(19) United States
(12) Patent Application Publication
(10) Pub. No.: US 2004/0031832 A1
(43) Pub. Date: Feb. 19, 2004

(54) Canoe rack

(76) Inventor: Gregory Crook, Acworth, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/457,211

(22) Filed: Jun. 9, 2003

Related U.S. Application Data
(60) Provisional application No. 60/386,918, filed on Jun. 7, 2002.

(51) Int. Cl. B60R 7/00; B60R 9/00; B60R 11/00

(52) U.S. Cl. 224/405; 224/548; 224/551; 224/552

(57) ABSTRACT

A rack that expeditiously and conveniently slidably engages and mounts the tailgate of a vehicle, or similarly suitable structure, for the simplified loading, support and securing of an article thereon.

### PRIORITY CLAIM

To the full extent permitted by law, the present application claims priority to and the benefit of the following application: as a nonprovisional patent application to provisional patent application entitled “Canoe Rack”, filed on Jun. 7, 2002, having assigned Serial No. 60/386,918.

### TECHNICAL FIELD

The present invention relates generally to boat racks, and more specifically to a canoe rack. The present invention is particularly suitable for, although not strictly limited to, transporting a canoe on a vehicle.

### BACKGROUND OF THE INVENTION

Whether for recreation or sport, canoeing has gained significant popularity amongst water-sport enthusiasts of all ages. Avid whitewater and/or quietwater paddlers can typically be found tackling some of the most rapidly flowing and large waterways, or enjoying the serene and peaceful atmosphere of a small local river. However, as with most boaters, canoe enthusiasts are often burdened by the inconvenience of having to load and transport their canoes to a desired waterway, a generally time-consuming and laborious task.

Although trailers for transporting canoes are available, most such trailers are unduly large and too awkward to attach to a vehicle. Moreover, most available trailers rarely, if ever, reduce the amount of time and effort expended in loading and securing a canoe thereto.

Therefore, it is readily apparent that there is a need for a canoe rack that expeditiously and conveniently attaches to the tailgate of a vehicle, or similarly suitable structure, for the simplified loading and securing of a canoe or similar article thereon.

### BRIEF SUMMARY OF THE INVENTION

Briefly described, in a preferred embodiment, the present invention overcomes the above-mentioned disadvantages and meets the recognized need for such a device by providing a canoe rack that expeditiously and conveniently slidably engages and mounts the tailgate of a vehicle, or similarly suitable structure, for the simplified loading and securing of a canoe or similar article thereon.

According to its major aspects and broadly stated, the present invention in its preferred form is a canoe rack having a mounting assembly and a support assembly, wherein the mounting assembly and support assembly preferably possess pads and/or padded material.

More specifically, the present invention is a canoe rack having a mounting assembly preferably possessing clasp members dimensioned to slidably engage and mount a conventional tailgate of a vehicle, or similarly suitable structure, wherein each clasp member preferably possesses padded arms. The clasp members are preferably connected via a crossbar, wherein the crossbar is also preferably padded. Attached preferably perpendicular to the crossbar is the support assembly, wherein the support assembly preferably possesses a telescoping support arm that assists in the elevated positioning and support of an inverted canoe placed thereon. The support arm preferably possess a support bar attached preferably perpendicular thereto, wherein the support bar is also preferably padded and preferably slightly curved or angled to assist in the stabilization of an inverted canoe placed thereon. The pads of the arms of the clasp members preferably rotate thereabout so as to assist in the sliding engagement and snug mounting of the clasp members onto a conventional tailgate of a vehicle, or similarly suitable structure. The pads of the canoe rack, in general, further preferably provide a frictionless contact between the pads and the surfaces in which the pads contact, thus giving the mounted canoe rack and supported canoe added stability. Additionally, the pads preferably prevent scratching and/or denting of the vehicle when the canoe rack is mounted thereon.

A feature and advantage of the present invention is its ability to expeditiously and conveniently attach to the tailgate of a vehicle, or similarly suitable structure, for the simplified loading and securing of a canoe thereon.

A feature and advantage of the present invention is its ability to adjust the elevation of a canoe supported thereon, thus assisting in the overall stability and balance of the supported canoe.

A feature and advantage of the present invention is its portability.

A feature and advantage of the present invention is its ease of use.

A feature and advantage of the present invention is its simplicity of design.

A feature and advantage of the present invention is its ease of storage.

A feature and advantage of the present invention is its durability.

A feature and advantage of the present invention is its ability to be adapted and/or altered to accommodate any size/width tailgate.

A feature and advantage of the present invention is its ability to be adapted and/or altered to accommodate any type of vehicle.

These and other objects, features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structures and refer to like elements throughout, and in which:

FIG. 1 is a front perspective view of a canoe rack according to a preferred embodiment of the present invention.

FIG. 2 is a front view of a canoe rack according to a preferred embodiment of the present invention.

FIG. 3 is a rear view of a canoe rack according to a preferred embodiment of the present invention.

FIG. 4 is a front view of a canoe rack according to a preferred embodiment of the present invention.

FIG. 5 is a partial side view of a canoe rack according to a preferred embodiment of the present invention.

FIG. 6 is a front perspective view of a canoe rack according to a preferred embodiment of the present invention, showing the device in use.

### DETAILED DESCRIPTION OF THE PREFERRED AND ALTERNATIVE EMBODIMENTS

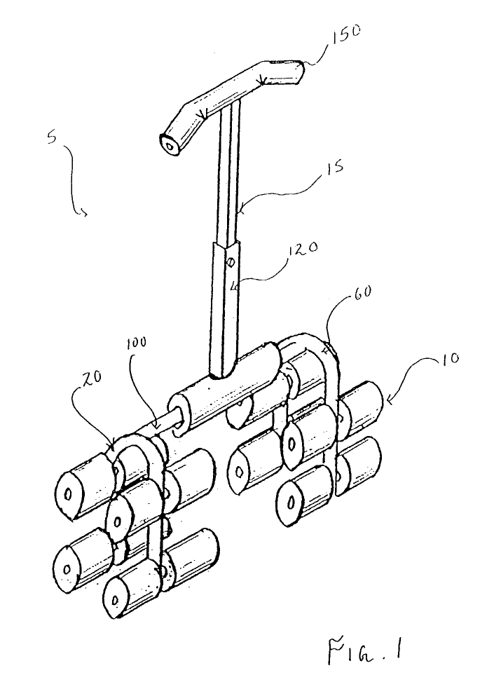

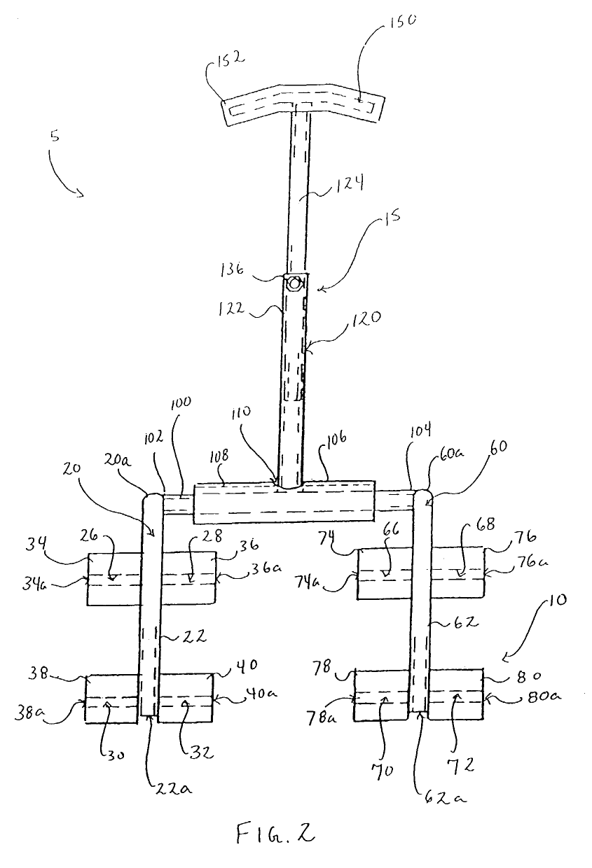

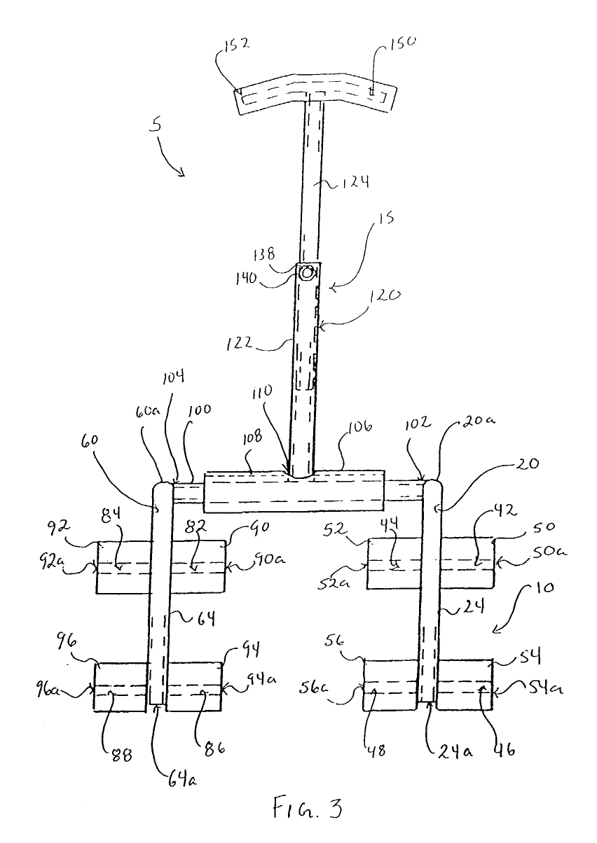

In describing the preferred and alternate embodiments of the present invention, as illustrated in FIGS. 1-6, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-3, the present invention in its preferred embodiment is a canoe rack 5 having mounting assembly 10 and support assembly 15.

Specifically, mounting assembly 10 preferably possesses clasp members 20 and 60 and crossbar 100. Clasp member 20 preferably defines an inverted U-shape, possessing first leg 22 and second leg 24, wherein the distance between first leg 22 and second leg 24 preferably permits clasp member 20 to slidably engage a conventional vehicle tailgate or similarly suitable structure. Clasp member 20 is preferably formed from a single cylindrical-shaped hollow pipe of strong, yet lightweight, metal material, such as for exemplary purposes only, aluminum or titanium, and preferably shaped via known metal bending/shaping means to form first leg 22 and second leg 24, thus giving clasp member 20 its overall inverted U-shape. Although metal is the preferred material of clasp member 20, other materials such as durable plastic, fiberglass and/or wood may also be utilized. Moreover, although first leg 22 and second leg 24 of clasp member 20 are preferably cylindrical-shaped, other suitable shapes, such as, for exemplary purposes only, rectangular, may be used. Alternatively, first leg 22 and second leg 24 could be welded together to form clasp member 20.

Preferably, opposing arms 26 and 28 are formed proximal the mid-region of first leg 22 of clasp member 20, and extend preferably perpendicularly therefrom. Similarly, opposing arms 30 and 32 are preferably formed proximal end 22a of first leg 22, and extend preferably perpendicularly therefrom. Arms 26, 28, 30 and 32 are preferably cylindrical-shaped hollow pipe of strong, yet lightweight, metal material, such as for exemplary purposes only, aluminum or titanium, and are preferably welded to first leg 22 and/or attached thereto via any attachment means known within the art, such as, for exemplary purposes only, adhesives, epoxies, resins and/or integrally formed therewith. Although metal is the preferred material of arms 26, 28, 30 and 32, other materials such as durable plastic, fiberglass and/or wood may also be utilized. Moreover, although arms 26, 28, 30 and 32 are preferably cylindrical-shaped, other suitable shapes, such as, for exemplary purposes only, rectangular, may be used.

Preferably encompassing each of arms 26, 28, 30 and 32 are pads 34, 36, 38 and 40, respectively. Pads 34, 36, 38 and 40 are preferably tubular-shaped and slidably engage arms 26, 28, 30 and 32, respectively, via channels 34a, 36a, 38a and 40a, respectively, formed therethrough. Channels 34a, 36a, 38a and 40a preferably enable pads 34, 36, 38 and 40, respectively, to rotate about arms 26, 28, 30 and 32, respectively, thus permitting first leg 22 to slidably engage and snugly contact a conventional vehicle tailgate or similarly suitable structure. Pads 34, 36, 38 and 40 are preferably formed from a sponge-foam material and/or any other padding material known with the art, such as, for exemplary purposes only, sponge encompassed within vinyl, leather and/or suede material, sponge encompassed within terry cloth, air-filled pads and/or pillows or cushions of any type. Furthermore, pads 34, 36, 38 and 40 are preferably slidably removable from arms 26, 28, 30 and 32, respectively, for replacement or repair thereof. Alternatively, pads 34, 36, 38 and 40 could each possess a lengthwise slit to assist in their removal from respective arms 26, 28, 30 and 32 of first leg 22. Pads 34, 36, 38 and 40 further preferably provide a frictionless contact between themselves and the vehicle surface in which pads 34, 36, 38 and 40 contact, thus giving mounted canoe rack 5 and the supported canoe added stability. Additionally, pads 34, 36, 38 and 40 preferably prevent scratching and/or denting of the vehicle surface when canoe rack 5 is mounted thereon. Although pads 34, 36, 38 and 40 are preferably tubular-shaped, other suitable shapes could be utilized, such as, for exemplary purposes only, rectangular.

Similarly, opposing arms 42 and 44 are formed proximal the mid-region of second leg 24 of clasp member 20, and extend preferably perpendicularly therefrom. Likewise, opposing arms 46 and 48 are preferably formed proximal end 24a of second leg 24, and extend preferably perpendicularly therefrom. In such a configuration, arms 42, 44, 46 and 48 of second leg 24 are preferably parallel to arms 26, 28, 30 and 32 of first leg 22 of clasp member 20. Arms 42, 44, 46 and 48 are preferably cylindrical-shaped hollow pipe of strong, yet lightweight, metal material, such as for exemplary purposes only, aluminum or titanium, and are preferably welded to second leg 24 and/or attached thereto via any attachment means known within the art, such as, for exemplary purposes only, adhesives, epoxies, resins and/or integrally formed therewith. Although metal is the preferred material of arms 42, 44, 46 and 48, other materials such as durable plastic, fiberglass and/or wood may also be utilized. Moreover, although arms 42, 44, 46 and 48 are preferably cylindrical-shaped, other suitable shapes, such as, for exemplary purposes only, rectangular, may be used.

Preferably encompassing each of arms 42, 44, 46 and 48 are pads 50, 52, 54 and 56, respectively. Pads 50, 52, 54 and 56 are preferably tubular-shaped and slidably engage arms 42, 44, 46 and 48, respectively, via channels 50a, 52a, 54a and 56a, respectively, formed therethrough. Channels 50a, 52a, 54a and 56a preferably enable pads 50, 52, 54 and 56, respectively, to rotate about arms 42, 44, 46 and 48, respectively, thus permitting second leg 24 to slidably engage and snugly contact a conventional vehicle tailgate, or similarly suitable structure, in conjunction with first leg 22 and cooperating pads 34, 36, 38 and 40, thereby securely maintaining clasp member 20 thereto. Pads 50, 52, 54 and 56 are preferably formed from a sponge-foam material and/or any other padding material known with the art, such as, for exemplary purposes only, sponge encompassed within vinyl, leather and/or suede material, sponge encompassed within terry cloth, air-filled pads and/or pillows or cushions of any type. Furthermore, pads 50, 52, 54 and 56 are preferably slidably removable from arms 42, 44, 46 and 48, respectively, for replacement or repair thereof. Alternatively, pads 50, 52, 54 and 56 could each possess a lengthwise slit to assist in their removal from respective arms 42, 44, 46 and 48 of second leg 24. Pads 50, 52, 54 and 56 further preferably provide a frictionless contact between themselves and the vehicle surface in which pads 50, 52, 54 and 56 contact, thus giving mounted canoe rack 5 and the supported canoe added stability. Additionally, pads 50, 52, 54 and 56 preferably prevent scratching and/or denting of the vehicle surface when canoe rack 5 is mounted thereon. Although pads 50, 52, 54 and 56 are preferably tubular-shaped, other suitable shapes could be utilized, such as, for exemplary purposes only, rectangular.

Clasp member 60 preferably also defines an inverted U-shape, possessing first leg 62 and second leg 64, wherein the distance between first leg 62 and second leg 64 preferably permits clasp member 60 to slidably engage a conventional vehicle tailgate or similarly suitable structure. Clasp member 60 is preferably formed from a single cylindrical-shaped hollow pipe of strong, yet lightweight, metal material, such as for exemplary purposes only, aluminum or titanium, and preferably shaped via known metal bending/shaping means to form first leg 62 and second leg 64, thus giving clasp member 60 its overall inverted U-shape. Although metal is the preferred material of clasp member 60, other materials such as durable plastic, fiberglass and/or wood may also be utilized. Moreover, although first leg 62 and second leg 64 of clasp member 60 are preferably cylindrical-shaped, other suitable shapes, such as, for exemplary purposes only, rectangular, may be used. Alternatively, first leg 62 and second leg 64 could be welded together to form clasp member 60.

Preferably, opposing arms 66 and 68 are formed proximal the mid-region of first leg 62 of clasp member 60, and extend preferably perpendicularly therefrom. Similarly, opposing arms 70 and 72 are preferably formed proximal end 62a of first leg 62, and extend preferably perpendicularly therefrom. Arms 66, 68, 70 and 72 are preferably cylindrical-shaped hollow pipe of strong, yet lightweight, metal material, such as for exemplary purposes only, aluminum or titanium, and are preferably welded to first leg 62 and/or attached thereto via any attachment means known within the art, such as, for exemplary purposes only, adhesives, epoxies, resins and/or integrally formed therewith. Although metal is the preferred material of arms 66, 68, 70 and 72, other materials such as durable plastic, fiberglass and/or wood may also be utilized. Moreover, although arms 66, 68, 70 and 72 are preferably cylindrical-shaped, other suitable shapes, such as, for exemplary purposes only, rectangular, may be used.

Preferably encompassing each of arms 66, 68, 70 and 72 are pads 74, 76, 78 and 80, respectively. Pads 74, 76, 78 and 80 are preferably tubular-shaped and slidably engage arms 66, 68, 70 and 72, respectively, via channels 74a, 76a, 78a and 80a, respectively, formed therethrough. Channels 74a, 76a, 78a and 80a preferably enable pads 74, 76, 78 and 80, respectively, to rotate about arms 66, 68, 70 and 72, respectively, thus permitting first leg 62 to slidably engage and snugly contact a conventional vehicle tailgate or similarly suitable structure. Pads 74, 76, 78 and 80 are preferably formed from a sponge-foam material and/or any other padding material known with the art, such as, for exemplary purposes only, sponge encompassed within vinyl, leather and/or suede material, sponge encompassed within terry cloth, air-filled pads and/or pillows or cushions of any type. Furthermore, pads 74, 76, 78 and 80 are preferably slidably removable from arms 66, 68, 70 and 72, respectively, for replacement or repair thereof. Alternatively, pads 74, 76, 78 and 80 could each possess a lengthwise slit to assist in their removal from respective arms 66, 68, 70 and 72 of first leg 62. Pads 74, 76, 78 and 80 further preferably provide a frictionless contact between themselves and the vehicle surface in which pads 74, 76, 78 and 80 contact, thus giving mounted canoe rack 5 and the supported canoe added stability. Additionally, pads 74, 76, 78 and 80 preferably prevent scratching and/or denting of the vehicle surface when canoe rack 5 is mounted thereon. Although pads 74, 76, 78 and 80 are preferably tubular-shaped, other suitable shapes could be utilized, such as, for exemplary purposes only, rectangular.

Similarly, opposing arms 82 and 84 are formed proximal the mid-region of second leg 64 of clasp member 60, and extend preferably perpendicularly therefrom. Likewise, opposing arms 86 and 88 are preferably formed proximal end 64a of second leg 64, and extend preferably perpendicularly therefrom. In such a configuration, arms 82, 84, 86 and 88 of second leg 64 are preferably parallel to arms 66, 68, 70 and 72 of first leg 62 of clasp member 60. Arms 82, 84, 86 and 88 are preferably cylindrical-shaped hollow pipe of strong, yet lightweight, metal material, such as for exemplary purposes only, aluminum or titanium, and are preferably welded to second leg 64 and/or attached thereto via any attachment means known within the art, such as, for exemplary purposes only, adhesives, epoxies, resins and/or integrally formed therewith. Although metal is the preferred material of arms 82, 84, 86 and 88, other materials such as durable plastic, fiberglass and/or wood may also be utilized. Moreover, although arms 82, 84, 86 and 88 are preferably cylindrical-shaped, other suitable shapes, such as, for exemplary purposes only, rectangular, may be used.

Preferably encompassing each of arms 82, 84, 86 and 88 are pads 90, 92, 94 and 96, respectively. Pads 90, 92, 94 and 96 are preferably tubular-shaped and slidably engage arms 82, 84, 86 and 88, respectively, via channels 90a, 92a, 94a and 96a, respectively, formed therethrough. Channels 90a, 92a, 94a and 96a preferably enable pads 90, 92, 94 and 96, respectively, to rotate about arms 82, 84, 86 and 88, respectively, thus permitting second leg 64 to slidably engage and snugly contact a conventional vehicle tailgate, or similarly suitable structure, in conjunction with first leg 62 and cooperating pads 74, 76, 78 and 80, thereby securely maintaining clasp member 60 thereto. Pads 90, 92, 94 and 96 are preferably formed from a sponge-foam material and/or any other padding material known with the art, such as, for exemplary purposes only, sponge encompassed within vinyl, leather and/or suede material, sponge encompassed within terry cloth, air-filled pads and/or pillows or cushions of any type. Furthermore, pads 90, 92, 94 and 96 are preferably slidably removable from arms 82, 84, 86 and 88, respectively, for replacement or repair thereof. Alternatively, pads 90, 92, 94 and 96 could each possess a lengthwise slit to assist in their removal from respective arms 82, 84, 86 and 88 of second leg 64. Pads 90, 92, 94 and 96 further preferably provide a frictionless contact between themselves and the vehicle surface in which pads 90, 92, 94 and 96 contact, thus giving mounted canoe rack 5 and the supported canoe added stability. Additionally, pads 90, 92, 94 and 96 preferably prevent scratching and/or denting of the vehicle surface when canoe rack 5 is mounted thereon. Although pads 90, 92, 94 and 96 are preferably tubular-shaped, other suitable shapes could be utilized, such as, for exemplary purposes only, rectangular.

Crossbar 100 of mounting assembly 10 is preferably formed from a single cylindrical-shaped hollow pipe of strong, yet lightweight, metal material, such as for exemplary purposes only, aluminum or titanium, and preferably possesses first end 102 and opposing second end 104. Although metal is the preferred material of crossbar 100, other materials such as durable plastic, fiberglass and/or wood may also be utilized. Moreover, although crossbar 100 is preferably cylindrical-shaped, other suitable shapes, such as, for exemplary purposes only, rectangular, may be used.

Preferably, first end 102 of crossbar 100 is attached to apex 20a of clasp member 20, and second end 104 of crossbar 100 is preferably attached to apex 60a of clasp member 60 via any known attaching means, such as, for exemplary purposes only, welding, adhesives, epoxies, resins and/or integrally formed therewith. In such a configuration, crossbar 100 preferably bridges and distances clasp members 20 and 60, thereby giving mounting assembly 10 further stability when engaged with a vehicle tailgate or similar suitable structure.

Crossbar 100 is preferably encompassed by pad 106, wherein pad 106 is preferably tubular-shaped and formed from a sponge-foam material and/or any other padding material known with the art, such as, for exemplary purposes only, sponge encompassed within vinyl, leather and/or suede material having a securing flap possessing hook-and-loop fasteners or a zipper, sponge encompassed within terry cloth, air-filled pads and/or pillows or cushions of any type. Pad 106 preferably possesses lengthwise slit 108 to assist in the removal of pad 106 from crossbar 100 for the replacement or repair thereof. Pad 106 further possesses square-shaped cutaway 110 centrally formed on slit 108, wherein cutaway 110 preferably allows attachment of support arm 120 of support assembly 15 to crossbar 100 and the extension of the same therefrom, as more fully detailed below. Pad 106 further preferably provides a frictionless contact between itself and the vehicle surface in which pad 106 contacts, thus giving mounted canoe rack 5 and the supported canoe added stability. Additionally, pad 106 preferably prevents scratching and/or denting of the vehicle surface when canoe rack 5 is mounted thereon. Although pad 106 is preferably tubular-shaped, other suitable shapes could be utilized, such as, for exemplary purposes only, rectangular.

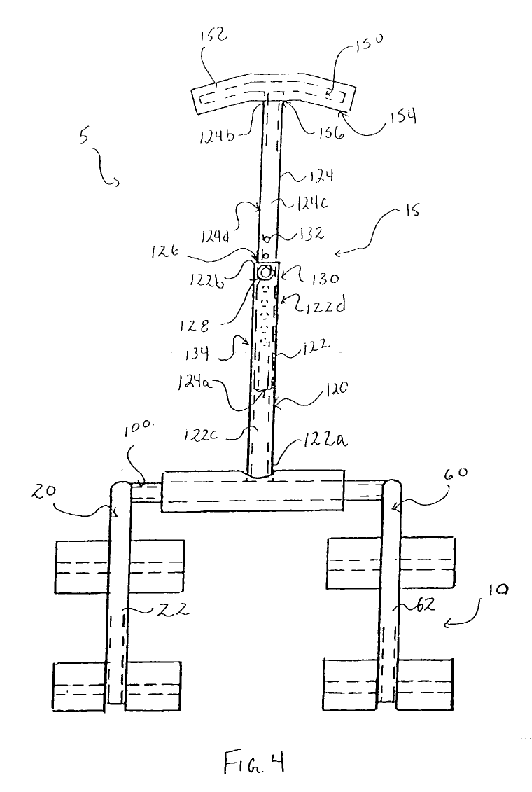

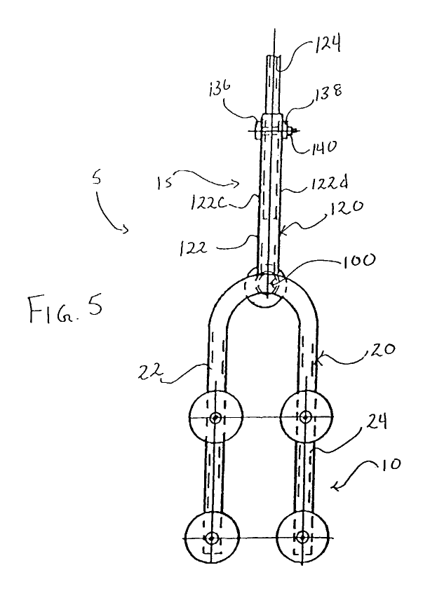

Referring now to FIGS. 4-5, support assembly 15 preferably possesses support arm 120 and support bar 150. Specifically, support arm 120 preferably possesses outer member 122 and inner member 124, wherein outer member 122 possesses first end 122a and second end 122b and inner member possesses first end 124a and 124b. First end 122a of outer member 122 preferably extends through cutaway 110 of pad 106 of crossbar 100, and is preferably attached to crossbar 100 via any known attaching means, such as, for exemplary purposes only, welding, adhesives, epoxies, resins and/or integrally formed therewith. Outer member 122 is preferably formed from a single rectangular-shaped hollow pipe of strong, yet lightweight, metal material, such as for exemplary purposes only, aluminum or titanium, and preferably possesses aperture 126 formed at second end 122b. Although metal is the preferred material of outer member 122, other materials such as durable plastic, fiberglass and/or wood may also be utilized. Moreover, although outer member is preferably rectangular-shaped, other suitable shapes, such as, for exemplary purposes only, cylindrical, may be used.

Inner member 124 is preferably formed from a single rectangular-shaped hollow pipe of strong, yet lightweight, metal material, such as for exemplary purposes only, aluminum or titanium, and is preferably dimensioned to be slidably received within outer member 122. Specifically, first end 124a of inner member 124 preferably extends through aperture 126 of outer member 122, thus allowing inner member 124 to be telescopically engaged therewith. Although metal is the preferred material of inner member 124, other materials such as durable plastic, fiberglass and/or wood may also be utilized. Moreover, although outer member 122 is preferably rectangular-shaped, other suitable shapes, such as, for exemplary purposes only, cylindrical, may be used.

Side 122c and opposing side 122d of outer member 122 preferably possess opposingly aligned throughholes 128 and 130, respectively, formed therethrough. In a similar fashion, side 124c and opposing side 124d of inner member 124 preferably possess opposingly aligned plurality of throughholes 132 and plurality of throughholes 134, respectively, formed therethrough, wherein side 124c of inner member 124 abuts side 122c of outer member 122, and wherein side 124d of inner member 124 abuts side 122d of outer member 122. Inner member 124 is preferably telescopically situated within outer member 122 at a desired height and locked therein via insertion of bolt 136 through throughhole 128, then through an aligned and corresponding throughhole of plurality of throughholes 132, then through the aligned and corresponding throughhole of plurality of throughholes 134, and thereafter through throughhole 130, wherein washer 138 and nut 140 preferably threadably receive and secure bolt 136. Inner member 124 and outer member 122 are preferably telescopically interactive to assist in the elevated positioning, balance and support of an inverted canoe placed on canoe rack 5. It is contemplated in an alternate embodiment that other telescoping and locking mechanisms could be utilized, such as, for exemplary purposes only, pressure-sensitive and/or spring-loaded lock-ball mechanisms, pneumatic mechanisms, setscrews, gear mechanisms and/or the like.

Preferably, support bar 150 is attached to second end 124b of inner member 124 via any known attaching means, such as, for exemplary purposes only, welding, adhesives, epoxies, resins and/or integrally formed therewith. Furthermore, support bar 150 is preferably perpendicular to support arm 120 and preferably parallel to crossbar 100 of mounting assembly 10. Support bar 150 is preferably formed from a single cylindrical-shaped hollow pipe of strong, yet lightweight, metal material, such as for exemplary purposes only, aluminum or titanium, and is preferably slightly curved or angled to accommodate the curved or angled interior structure of a canoe, thereby assisting in the stabilization of an inverted canoe placed thereon. Although metal is the preferred material of support bar 150, other materials such as durable plastic, fiberglass and/or wood may also be utilized. Moreover, although support bar 150 is preferably cylindrical-shaped, other suitable shapes, such as, for exemplary purposes only, rectangular, may be used.

Support bar 150 is preferably encompassed by pad 152, wherein pad 152 is preferably tubular-shaped and formed from a sponge-foam material and/or any other padding material known with the art, such as, for exemplary purposes only, sponge encompassed within vinyl, leather and/or suede material having a securing flap possessing hook-and-loop fasteners or a zipper, sponge encompassed within terry cloth, air-filled pads and/or pillows or cushions of any type. Pad 152 preferably possesses lengthwise slit 154 to assist in the removal of pad 152 from support bar 150 for the replacement or repair thereof. Pad 152 further possesses square-shaped cutaway 156 centrally formed on slit 154, wherein cutaway 156 preferably accommodates second end 124b of inner member 124. Pad 152 further preferably provides a frictionless contact between itself and the canoe interior in which pad 152 contacts, thus giving the supported canoe added stability. Additionally, pad 152 preferably prevents scratching and/or denting of the canoe interior surface when in contact therewith. Although pad 152 is preferably tubular-shaped, other suitable shapes could be utilized, such as, for exemplary purposes only, rectangular.

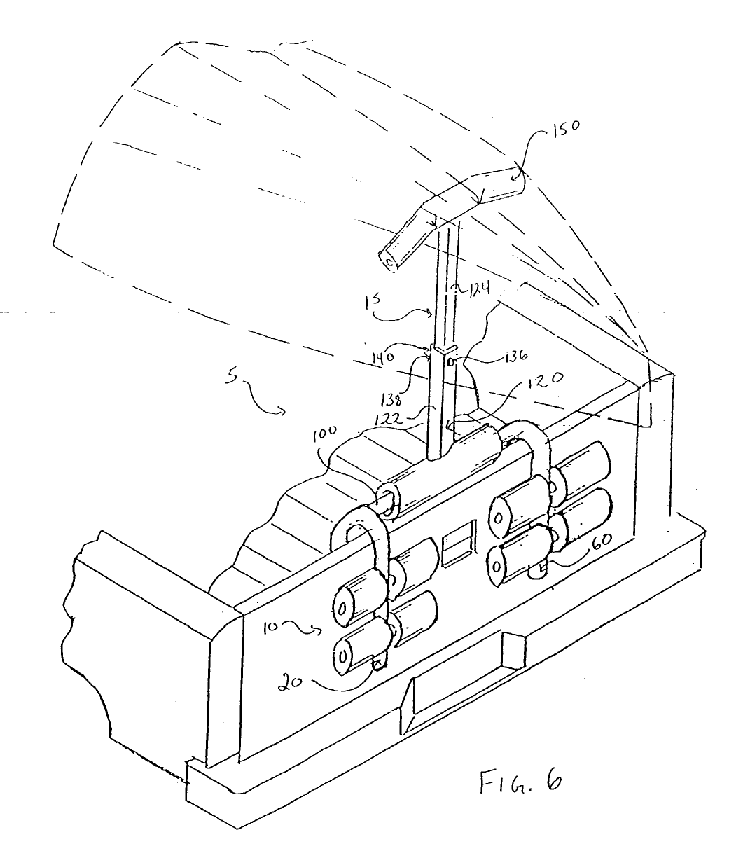

Referring now to FIG. 6, in use, canoe rack 5 is adapted to a vehicle's tailgate or similar structure by slidably engaging clasp members 20 and 60 of mounting structure 10 over the tailgate or structure. Thereafter, inner member 124 of support arm 120 of support assembly 15 is preferably telescopically adjusted within outer member 122 of support arm 120 and locked therein via bolt 136, washer 138 and nut 140. A canoe is preferably placed onto support bar 150 of support assembly 15 in an inverted manner, such that the interior of the canoe abuts support bar 150. The canoe can be further secured to the vehicle or structure via ropes, tethers or any other desired securing means.

It is contemplated in an alternate embodiment that canoe rack 5 could be modified to enable clasp members 20 and 60 to slidably engage any wall/structure of a vehicle.

It is contemplated in another alternate embodiment that canoe rack 5 could be modified to enable clasp members 20 and 60 to slidably engage any structure.

It is contemplated in another alternate embodiment that canoe rack 5 could be modified to adapt to any means of transportation.

It is contemplated in yet another alternate embodiment that canoe rack 5 could possess any number of clasp members.

It is contemplated in yet another alternate embodiment that canoe rack 5 could possess any number of pads and arms.

It is contemplated in yet another alternate embodiment that canoe rack 5 could possess no pads, but instead possess a foam-sponge skin.

It is contemplated in still another alternate embodiment that canoe rack 5 could possess any number of support arms.

It is contemplated in still another alternate embodiment that canoe rack 5 could possess any number of support bars.

It is contemplated in still another alternate embodiment that canoe rack 5 could be modified to accommodate and support any boat.

It is contemplated in still another alternate embodiment that canoe rack 5 could be modified to accommodate and support any large structure or item.

It is contemplated in still another alternate embodiment that canoe rack 5 could be manufactured to any size to accommodate and support any sized structure or item.

It is contemplated in still another alternate embodiment that canoe rack 5 could possess securing straps, tethers, bungee cords, ropes and/or any other similar and/or suitable securing means to further assist in the secured transportation of a canoe or similar structure carried thereon.

It is contemplated in still another alternate embodiment that support arm 120 could utilize other telescoping and locking mechanisms, such as, for exemplary purposes only, pressure-sensitive and/or spring-loaded lock-ball mechanisms, pneumatic mechanisms, setscrews, gear mechanisms and/or the like.

It is contemplated in still another alternate embodiment that crossbar 100 could be hingably attached to clasp members 20 and 60 so as to enable the hingable folding thereabout.

It is contemplated in still another alternate embodiment that canoe rack 5 could possess hinging mechanisms to enable the hingable folding thereof.

It is contemplated in still another alternate embodiment that arms 26, 28, 30, 32, 42, 44, 46 and 48 and arms 66, 68, 70, 72, 82, 84, 86 and 88 of clasp members 20 and 60, respectively, could be rotatable themselves to further facilitate slidable engagement of mounting member 10 of canoe rack 5 with a desired vehicle or structure.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A rack, comprising:
at least one support arm;
at least one clasp member carried by said at least one support arm;
at least one support bar carried by said at least one support arm.

2. The rack of claim 1, wherein said at least one support arm is approximately perpendicularly positioned on said at least one clasp member.

3. The rack of claim 1, wherein said at least one support bar is perpendicularly positioned on said at least one support arm, said support bar comprising at least a partially curved shape.

4. The rack of claim 1, wherein said at least one clasp member comprises a first leg and a second leg, said first leg and said second leg being approximately parallel to one another.

5. The rack of claim 1, wherein at least one crossbar connects said at least one clasp member with a second said at least one clasp member.

6. The rack of claim 5, wherein said at least one crossbar comprises at least one pad.

7. The rack of claim 1, wherein said at least one support arm comprises an inner member telescopically engaged with an outer member, said inner member adapted to be lockably fixed at a selected position within said outer member.

8. The rack of claim 7, wherein said inner member of said at least one support arm is carried by said at least one support bar.

9. The rack of claim 1 further comprising at least one pad carried by said at least one clasp member and said at least one support bar.

10. A rack, comprising:
at least one support arm;
at least one clasp member carried by said at least one support arm, said clasp member having a first leg and a second leg; and
at least one support bar carried by said at least one support arm.

11. The rack of claim 10, wherein said at least one support arm is approximately perpendicularly positioned on said at least one clasp member.

12. The rack of claim 10, wherein said at least one support bar is approximately perpendicularly positioned on said at least one support arm, said support bar comprising at least a partially curved shape.

13. The rack of claim 10, wherein at least one crossbar connects said at least one clasp member with a second said at least one clasp member.

14. The rack of claim 13, wherein said at least one crossbar comprises at least one pad.

15. The rack of claim 10, wherein said at least one support arm comprises an inner member telescopically engaged with an outer member, said inner member adapted to be lockably fixed at a selected position within said outer member.

16. The rack of claim 15, wherein said inner member of said at least one support arm is carried by said at least one support bar.

17. The rack of claim 10 further comprising at least one pad carried by said at least one clasp member and said at least one support bar.

18. A canoe rack, comprising:
at least one clasp member, said clasp member having a first leg and a second leg;
at least one support arm approximately perpendicularly positioned on said at least one clasp member, said at least one support arm comprising an inner member telescopically engaged with an outer member and said inner member adapted to be lockably fixed at a selected position within said outer member;
at least one support bar approximately perpendicularly positioned on said inner member of said at least one support arm;
at least one pad carried by said at least one clasp member; and
at least one pad carried by said at least one support bar.

19. The rack of claim 18, wherein said at least one support bar is at least partially curved.

20. The rack of claim 18, wherein at least one crossbar connects said at least one clasp member with a second said at least one clasp member, and wherein said at least one crossbar comprises at least one pad.
